(19) United States
(12) Patent Application Publication
(10) Pub. No.: US 2014/0219112 A1
(43) Pub. Date: Aug. 7, 2014

(54) SELECTIVE PRIORITIZATION OF DATA PACKETS TO IMPROVE DATA TRAFFIC

(71) Applicant: BROADCOM CORPORATION, Irvine, CA (US)

(72) Inventors: Arzad Kherani, Bangalore (IN); Rishi Ranjan, Sunnyvale, CA (US)

(73) Assignee: BROADCOM CORPORATION, Irvine, CA (US)

(21) Appl. No.: 13/793,677

(22) Filed: Mar. 11, 2013

Related U.S. Application Data
(60) Provisional application No. 61/762,006, filed on Feb. 7, 2013.

(51) Int. Cl. H04W 72/10; H04L 9/28

(52) U.S. Cl. CPC H04W 72/10; H04L 9/28
USPC 370/252; 370/329; 380/255

(57) ABSTRACT

Techniques are described herein for prioritizing higher priority data packets by reserving sequence numbers for assignment to higher priority data packets received after lower priority data packets are assigned sequence numbers. Higher priority data packets may also be prioritized by estimating an amount of data that can be sent in a single uplink allocation, limiting the amount of data packet data sent during a designated uplink allocation to the estimated amount of data, and encrypting high priority data packet(s) received previous to the designated uplink allocation. Higher priority data packets may also be prioritized by encrypting and placing high priority data packet(s) received in a queue, and subsequently re-encrypting any unsent lower priority data packets that were encrypted in the queue before the high priority data packet(s) were received.

This application claims the benefit of U.S. Provisional Application No. 61/762,006, filed on Feb. 7, 2013, which is incorporated by reference herein in its entirety.

### BACKGROUND

1. Technical Field

The present application generally relates to the prioritization of packets in a network communications protocol suite. In particular, the present application is related to the selective prioritizing of high priority traffic packets using the packet data convergence protocol of the long-term environment (LTE) standard.

2. Background

Many types of communication devices exist that enable users to wirelessly communicate data with each other. Examples of such communication devices include cell phones, VoIP (voice over Internet protocol) phones, portable computers, etc. LTE (long term evolution) is an example of a standard for wireless communication of high speed data between communication devices. LTE is considered to be a fourth generation (4G) communication standard, and is a successor to third generation (3G) and second generation (2G) mobile communication standards. LTE may be implemented in a multilayer computer networking protocol suite or stack in a communication device. A packet data convergence protocol (PDCP) layer is an example of a protocol layer included in the LTE protocol stack. Among other things, PDCP performs IP (Internet protocol) packet header compression and decompression, and maintenance of packet sequence numbers. TCP (transmission control protocol) is a networking protocol that is frequently used in communication devices, including devices operating according to the LTE standard, to wirelessly communicate data packets.

Communications between communications devices are often carried out over asymmetrical communication links. In many asymmetrical communications, the upload data rate available to transmit data from a mobile communication device to a base station (e.g., a cell tower) is lower than the download data rate used to transmit data from the base station to the user device. One well-documented problem that results from this is that the download performance can be slow when large files are being uploaded from a communication device to the base station. Each time a data packet is downloaded to the communication device from a TCP server through the base station, the communication device generates and transmits a corresponding TCP acknowledgement (ACK) packet. The TCP ACK packet informs the server that the data packet was received by the communication device without errors. The server has to receive the TCP ACK packet for the prior data packet before the server sends a next data packet for download. However, if a large file is being uploaded from the user device in the form of large packets (e.g., 1400 bytes), the relatively small TCP ACK packets (e.g., 40 bytes) have to be sent to the server at some point between these large packets. The larger the upload packet size, the lower the frequency at which these TCP ACK packets are sent. As such, the rate at which the server receives the TCP ACK packets is reduced, leading to delays in the server sending the next packets to the communication device. This reduces the overall data rate for downloading data to the communication device.

### BRIEF SUMMARY

Methods, systems, and apparatuses are described for selective prioritization of uplink data packets in a communications device substantially as shown in and/or described herein in connection with at least one of the figures, as set forth more completely in the claims.

### BRIEF DESCRIPTION OF THE DRAWINGS/FIGURES

The accompanying drawings, which are incorporated herein and form part of the specification, illustrate embodiments of the present application and, together with the description, further serve to explain the principles involved and to enable a person skilled in the relevant art(s) to make and use the disclosed embodiments.

FIGS. 1 and 2 depict block diagrams of example communications systems in accordance with embodiments described herein.

FIG. 3 depicts a block diagram view of example asymmetrical data streams, according to an embodiment.

FIGS. 4, 7, and 12 depict flowcharts of example methods of prioritizing packets in accordance with embodiments described herein.

FIG. 5 depicts a block diagram view of data packet queues containing packets being prioritized by puncturing sequence numbers, according to an example embodiment.

FIG. 6 shows a block diagram of a packet prioritization system that may operate according to the flowchart of FIG. 4, according to an example embodiment.

FIGS. 8-10 show block diagram views of examples of data packet queues containing packets being prioritized by encrypting a quantity of data that corresponds to a single allocation, according to embodiments.

FIG. 11 shows a block diagram of a packet prioritization system that may operate according to the flowchart of FIG. 7, according to an example embodiment.

FIG. 13 shows a block diagram view of data packet queues containing packets being prioritized by encrypting higher priority packets when received and re-encrypting unsent lower-priority packets waiting in the queue, according to embodiments.

FIG. 14 shows a block diagram of a packet prioritization system that may operate according to the flowchart of FIG. 12, according to an example embodiment.

FIG. 15 is a block diagram of a computer in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description refers to the accompanying drawings that illustrate exemplary embodiments of the present application. However, the scope of the present application is not limited to these embodiments, but is instead defined by the appended claims. Thus, embodiments beyond those shown in the accompanying drawings, such as modified versions of the illustrated embodiments, may nevertheless be encompassed by the present application.

The detailed description describes steps corresponding to the flowcharts depicted in the accompanying drawings. It will be recognized that such steps can be performed in any order unless otherwise stated in the application.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. In addition, the term “based on” may be understood as not necessarily intended to convey an exclusive set of factors and may, instead, allow for existence of additional factors not necessarily expressly described, again, depending at least in part on context.

Numerous embodiments are described herein for prioritizing particular data packets for being transmitted from a communications device to a base station (e.g., uplink data packets). Among other things, such embodiments may enable a higher volume of downlink data to be received by the communications device by enabling acknowledgement packets for received data packets to be transmitted from the communication device at an increased frequency, thereby enabling a server for the data packets to provide next data packets at an increased frequency.

For instance, example embodiments are capable of prioritizing data packets by reserving high priority packet sequence numbers for the data packets. Sequence numbers that are assigned to data packets indicate an order in which the data packets are to be transmitted from a communications device. In an embodiment, sequence numbers may be reserved for later assignment to data packets deemed to be high priority, even while sequence numbers before and after the reserved sequence numbers are currently assigned to other data packets.

Further embodiments are capable of prioritizing relatively high priority packets by encrypting no more than the estimated amount of data that may fill a single uplink allocation. A single uplink allocation is an estimated amount of data that can be sent from a user device to be received by a base station in a particular communication environment at a particular point in time. For instance, the amount of data to be included in a single uplink allocation may be estimated based on the difference between an amount of power that the base station transmits to the user device and the amount of power that the user device receives from the base station at a particular time.

Further embodiments are capable of prioritizing relatively high priority packets by moving the packets ahead of other lower priority packets that have already been encrypted and are stored for transmission in a queue. The high priority packets are encrypted (e.g., using sequence numbers that were used by the encrypted lower priority packets), one or more of the unsent lower priority packets in the queue are re-encrypted (e.g., using unused sequence numbers), and the newly encrypted high priority packets are stored for transmission ahead of the re-encrypted lower priority packets in the queue.

Techniques described herein for prioritizing relatively high priority packets offer a variety of benefits as compared to conventional techniques. For example, the techniques described herein provide the ability to prioritize higher priority packets over lower priority packets. In accordance with the examples presented in this application, packets mapped to a single instance of a packet data convergence protocol (PDCP) entity, a PDCP being a protocol layer of a (long term evolution) LTE communications system, may be prioritized in a manner that fulfills the requirements of the LTE standard. In other embodiments, packets may be prioritized as described herein in other wireless communication standards that are currently known or to be developed in the future.

Numerous embodiments described herein include the encrypting of data packets (e.g., using encryption logic). Such data packets may be encrypted in a PDCP layer or other layer in a manner as would be known to persons skilled in the relevant art(s), according to any suitable encryption technique.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### II. Example Embodiments

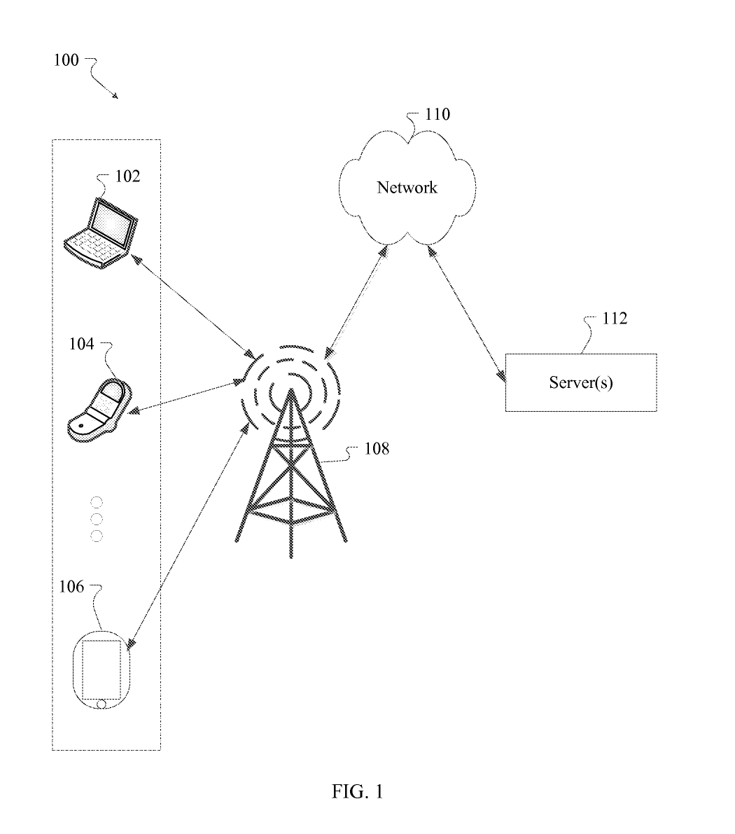

Embodiments may be implemented in various types of communication systems. For instance, FIG. 1 is a block diagram of an example communications system 100, in accordance with an embodiment. Generally speaking, communications system 100 operates to provide network communication between wireless and wired computing devices, including user devices and servers. The network communications may facilitate the transfer of data (including e.g., Web pages, images, video files, etc.), output of executables, and/or any other suitable type of information between networked computing devices, including, but not limited to wireless user devices and wired servers. For example, communications system 100 may facilitate the transfer of data wirelessly from a user device to a base station, and thereby to a networked computing device. Furthermore, communications system 100 may facilitate the downlink of data from a computing device to a base station, and thereafter wirelessly from the base station to a user device. In accordance with this example, user devices and base stations may operate to prioritize higher priority packets to be communicated over a wireless communications medium. Embodiments providing techniques for prioritizing packets are provided in the following description.

As shown in FIG. 1, communications system 100 includes a plurality of user devices 102, 104, . . . 106, a base station 108, a network 110, and one or more servers 112. Communication among user devices 102, 104, . . . 106 and servers 112 is carried out via base station 108 and network 110 using well-known network communication media. Base station 108 may provide a wireless connection to user devices 102, 104, . . . 106 using any wireless standard (e.g., 3G, LTE, or WIMAX). Base station 108 may also support a wired and/or wireless network connection to network 110, and server(s) 112 may support a wired and/or wireless network connection to network 110, using any wireless and/or wired media standard, such as Ethernet IEEE 802.3, etc. Network 110 may be a wide-area network (e.g., the Internet), a local area network (LAN), another type of network, or a combination thereof.

User devices 102, 104, . . . 106 are computing devices that are capable of communicating with base station 108 and server(s) 112. Three user devices are shown in FIG. 1 for illustrative purposes and are not intended to be limiting. Furthermore, server(s) 112 may include any number of one or more servers. It will be recognized by persons skilled in the relevant art(s) that communications system 100 may include any number of user devices, base stations, and servers. An example of a user device is a system that includes at least one processor, is capable of manipulating data in accordance with a set of instructions, and can communicate over a wireless connection. For instance, a user device may be a laptop computer, a mobile phone, a smart phone, a tablet computer, a netbook, a personal digital assistant, etc. User devices 102, 104, . . . 106 are configured to send data to and receive information from base station 108. Base station 108 may be an endpoint destination for the exchange of data, or it may be a network connection that relays data between user devices 102, 104, . . . 106 and other computing devices (e.g., a cell tower, etc.). For instance, a user device may initiate a request for information using a client (e.g., a Web browser, a Web crawler, a non-Web-enabled client, etc.) deployed on a user device 102 that is owned by or otherwise accessible to the user. In accordance with some example embodiments, user devices 102, 104, . . . 106 are capable of accessing Web sites hosted by server(s) 112, so that user devices 102, 104, . . . 106 may access information that is available via the Web sites. Such Web sites include Web pages, which may be provided as hypertext markup language (HTML) documents and objects (e.g., files) that are linked therein, for example.

Server(s) 112 are processing systems that are capable of communicating with user devices 102, 104, . . . 106. Server(s) 112 are configured to execute computer programs that provide information to users in response to receiving requests from the users. For example, the information may include documents (e.g., Web pages, images, video files, etc.), data, and/or any other suitable type of information. In accordance with some example embodiments, server(s) 112 are configured to host respective Web sites, so that the Web sites are accessible to users of communications system 100.

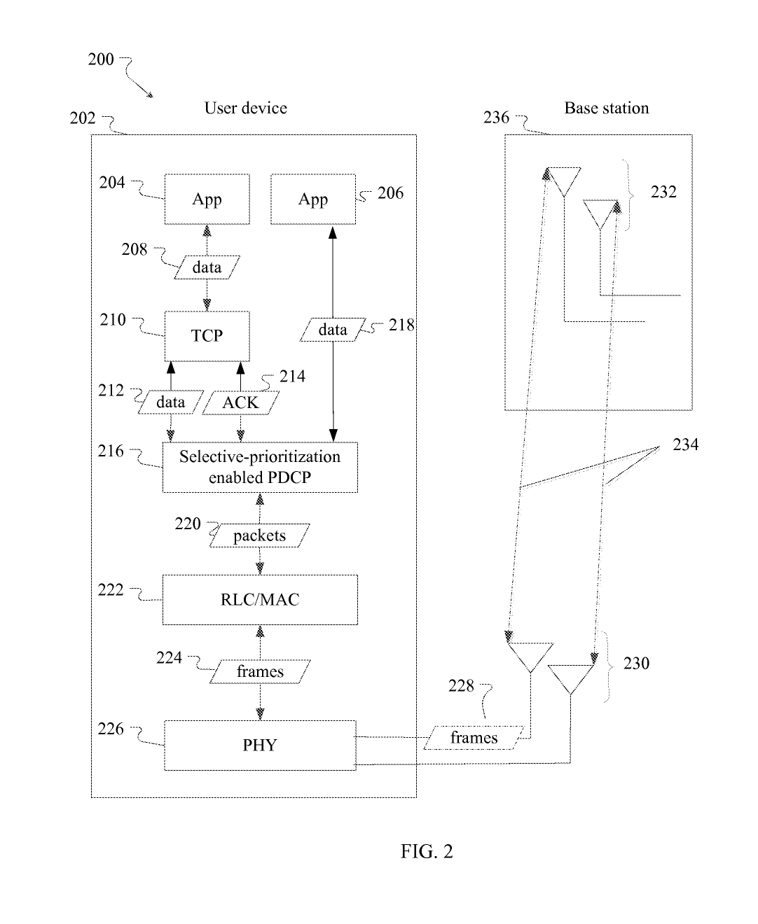

User devices, 102, 104, 106, etc., and base station 108 may be implemented in various ways in embodiments. For instance, FIG. 2 shows a block diagram of an example communications system 200, according to an embodiment. Communications system 200 includes a user device 202 and a base station 236. User device 202 is an example of any of user devices 102, 104 . . . 106. Similarly, base station 236 is an example of base station 108. In the LTE wireless standard, a user device is known as user equipment (UE) and a base station is known as eNodeb, and thus user device 202 may be referred to as user equipment, and base station 108 may be referred to as an eNodeb. User device 202 may include a plurality of layers of a protocol stack that comply with the LTE standard. A protocol stack is a specific implementation of a protocol suite, or a computer networking protocol suite, in a computing device. One example of a protocol suite is the protocol suite defined by the LTE standard.

A layer is a logical grouping of communications functions. The layers of user device 202 are arranged in a stack (e.g., in a protocol stack of a modem included in user device 202) that includes applications 204 and 206 (an application layer), a transmission control protocol (TCP) layer 210, a selective-prioritization enabled PDCP layer 216, a radio link control/medium access control (RLC/MAC) layer 222, and a physical layer 226. Each respective layer in the stack can communicate with the higher layer above it and the lower layer below it, if indeed there is a higher or lower layer adjacent to a respective layer. Further layers that are not shown in FIG. 2 may present in the stack in some implementations. A data payload may be transferred between each layer from the highest layer of the stack (the application layer, in this example) and the lowest layer of the stack (physical layer 226 in this example).

The application layer represents the highest layer of the protocol stack, meaning that applications 204 and 206 are either the closest to interacting with, or interact directly with the end user. For instance, application 204 is a type of application that relies on TCP to manage the transfer of information to a remote computing device. As such, application 204 sends and receives data 208 to/from TCP layer 210. Application 204 represents any computer application (e.g., an application, an mobile “app”, etc.) that can operate on a computing device. For example, application 204 could be an app for interfacing with a social network application (e.g., Facebook® operated by Facebook, Inc. of Palo Alto, Calif., and Google+® operated by Google, Inc. of Mountain View, Calif., etc.), a web browser (e.g., Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif., etc.), a mapping tool (e.g., Yahoo!® Maps, MapQuest®, and Google® Maps, etc.), or any other mobile or other type of application that can operate on user device 202 and relies on TCP. Data 208 represents any data that may be sent by an application over a network.

TCP layer 210 transmits (sends) and receives data 208 to and from application 204. TCP layer 210 also sends and receives data 212 and a TCP acknowledgment (TCP ACK) packet 214 to selective-prioritization enabled packet PDCP layer 216. In accordance with embodiments described herein, TCP layer 210 may manage the transfer of data between application 204 and a remote computing device (not shown) accessible via a wireless connection.

Upon receiving data 212 from the PDCP layer 216, TCP layer 210 may forward the data to application 204 in data 208, or visa-versa. TCP layer 210 may also send a TCP ACK packet 214 via PDCP layer 216, RLC/MAC layer 222, and PHY layer 226 to the server that originated data 212, confirming that data 212 was received from the server by TCP layer 210 without error. In some embodiments, the server will not send additional data to user device 202 until the server receives TCP ACK packet 214 for prior data transmitted to user device 202 by the server. Similarly, TCP layer 210 may also wait to receive a TCP ACK packet 214 via PDCP layer 216 when TCP layer 210 is sending data to a remote server. The TCP ACK packet confirms that data 212 was sent by TCP layer 210 without error. In some embodiments, the TCP layer 210 will not send additional data to the remote server until TCP layer 210 receives a TCP ACK packet.

Application 206 is a type of application that does not require TCP to manage the transfer of information to a remote computing device, and may instead use, for example, user datagram protocol (UDP, not shown in FIG. 2) to send and receive data 218 to PDCP layer 216 (rather than through TCP layer 210). For example, application 206 may be Skype®, owned by Microsoft Corporation, or another voice over IP (VoIP) application. Those skilled in the relevant art(s) will realize that there may be other protocols besides TCP and UDP that may be used to communicate between the Application 206 and PDCP layer 216.

At least in part, PDCP layer 216 performs compression and decompression of data packets (including encryption and decryption), as well as the assignment and maintenance of sequence numbers for data packets, as known to persons skilled in the relevant art(s). PDCP layer 216 communicates with higher layers in the protocol stack by sending and receiving data 212 and TCP ACK packets 214 to and from TCP layer 210, and sending and receiving data 218 to and from application 206. PDCP layer 216 also communicates with lower layers by sending and receiving packets 220 with RLC/MAC 222. In embodiments, PDCP layer 216 may be configured to selectively prioritize information, including data 212 and 218 and TCP ACK packets 214, before sending the information to RLC/MAC layer 222 via packets 220. In an embodiment, PDCP layer 216 may perform this function for data packets that are mapped to a same bearer.

At least in part, the RLC portion (e.g., sub-layer) of RLC/MAC layer 222 detects packet losses, and handles retransmissions and segmentation, as known to persons skilled in the relevant art(s). The MAC portion (e.g., sub-layer) of RLC/MAC layer 222 performs functions that include mapping and multiplexing of logical channels to transport channels, as is known to persons skilled in the relevant art(s). RLC/MAC layer 222 communicates with higher layers in the protocol stack by sending and receiving packets 220 to and from PDCP layer 216. RLC/MAC 222 sends and receives frames 224 to and from physical layer 226.

Physical layer 226 communicates with higher layers by sending and receiving frames 224 to and from RLC/MAC 222. Physical layer 226 is the lowest layer in the protocol suite of user device 202, managing the physical sending and receiving of frames 228 to base station 236 over antennas 230. As shown in FIG. 2, antennas 230 may include first and second antennas, but in other embodiments may include other numbers of antennas. Physical layer 226 may include a transmitter and receiver (e.g., a transceiver) used to transmit and receive signals that contain data packets using antennas 230.

Frames 228 are communicated between physical layer 226 and a receiver/transmitter of base station 236 over a duplex wireless signal 234. Duplex wireless signal 234 is represented by two double-sided dot-dash arrows between antennas 230 at user device 202 and antennas 232 at base station 236. Antennas 232 are coupled to the receiver/transmitter at base station 236. The transmitters and receivers of physical layer 226 and of base station 236 may utilize any electromagnetic frequency, or set of frequencies, that supports wireless communication to communicate using duplex wireless signal 234.

Base station 236 may also operate an LTE protocol stack similar to the stack shown in FIG. 2 and described above for user device 202, or may use a different stack configuration. For the sake of simplicity, a depiction of the protocol stack of base station 236 is not shown in FIG. 2.

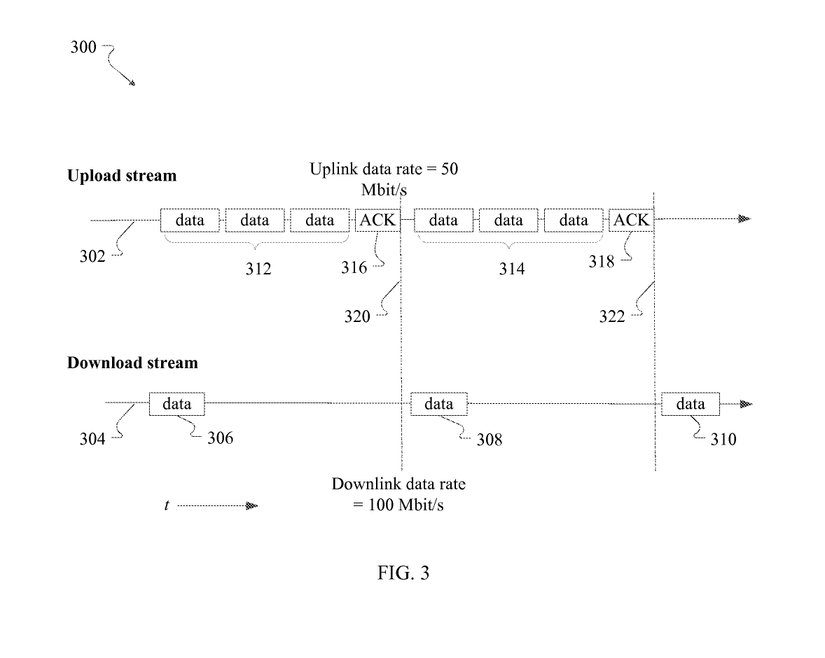

FIG. 3 depicts a block diagram view of example asymmetrical data streams 300, according to an embodiment. Data streams 300 are an example of an asymmetrical traffic flow into and out of a user device. For example, data streams 300 may be an example of duplex wireless signal 234 communicated between user device 202 and base station 236 of FIG. 2. In FIG. 3, data flow is shown with respect to time (t), which is increasing in the rightward direction. FIG. 3 is described as follows.

The user device (not shown in FIG. 3) supports an upload stream 302 of packets, represented by an arrow pointing to the right, originating in a user device (such as one of user devices 102, 104, . . . 106, and 202 of FIGS. 1 and 2). Upload stream 302 is transmitted by the user device, and received by a server such as one of server(s) 112 (of FIG. 1). The user device also receives a download stream 304 of packets, represented by a second arrow pointing to the right, which is transmitted by the server. The arrows shown in FIG. 3 for upload stream 302 and download stream 304 represent the data flowing into and out of a network interface of the user device. In the example of FIG. 3, upload stream 302 carries an uplink data rate of 50 Mbit/s and download stream 304 carries a downlink data rate of 100 Mbit/s, but those skilled in the art(s) will recognize that other speeds are also possible. Thus, the example of FIG. 3 represents a scenario where there is asymmetrical traffic flow though a user device, with the downlink data rate being faster than the uplink data rate.

Download data packets 306, 308, and 310 are downloaded to the user device in download stream 304. In the example of FIG. 3, download data packets 306, 308, and 310 are a series of download packets sent by a single server. Upload data packets 312 and 314 are uploaded from the user device in upload stream 302. In the example of FIG. 3, upload data packets 312 and 314 are each a respective series of upload packets destined for a single server. In the example of FIG. 3, a series of three upload data packets 312, representing a single upload file, are sent between download data packets 306 and 308, and a series of three upload data packets 314, also representing a single upload file, are sent between download data packets 308 and 310. Upload data packets 312 and 314 may take longer to upload than download packets 306, 308 and 310 take to be downloaded because upload stream 302 has a lower data rate than the data rate of download stream 304.

As shown in FIG. 3, TCP ACK packets 316 and 318 are uploaded from the user device to the server in upload stream 302. TCP ACK packets 316 and 318 are transmitted to acknowledge to the server that the user device has respectively received download packets 306 and 308 error-free. The server transmits download data packet 306, and then waits to receive TCP ACK packet 316 before sending the next download packet in the series, which is download data packet 308. A first time marker 320 depicted as a vertical dotted line drawn to the right of TCP ACK packet 316 and to the left of download data packet 308, indicates that download data packet 308 is sent by the server after TCP ACK packet 316 is received. After sending download data packet 308, the server waits to receive TCP ACK packet 318 before sending the next download packet in the series, which is download data packet 310. A second time marker 322, depicted as a vertical dotted line drawn to the right of TCP ACK packet 318 and to the left of download data 310, indicates that download data packet 310 is sent by the server after TCP ACK packet 318 is received.

In an embodiment, a window of download data packets may be transmitted before waiting to receive a TCP ACK packet. Download data packets 306, 308, and 310 may be included in a window that includes a plurality of download data packets, or may each represent a window that includes a plurality of data packet instead of a single packet. Once an entire window of download data packets has been transmitted, a server may wait to receive TCP ACK packets before transmitting the next packet in a series of download data packets. For example, if a TCP window is negotiated to be 64 packets in size, a server can send 64 download data packets without waiting for TCP ACK packets. If download data packets 0-63 have been transmitted and the server has not received a TCP ACK packet for packet 0, the server will stop sending new packets, and will not send a next packet until a TCP ACK packet is received.

Accordingly, a common problem that users experience with asymmetrical communication in user devices occurs when users upload large data files to a server, such as photos or movie files. The large data files may be sent in a single upload data packet, or divided into a series of smaller upload data packets 312 and 314 for transmission. Because upload data packets 312 and 314 take longer to transmit than download data packets 306, 308 and 310, there is latency introduced in sending TCP ACK packets 316 and 318, which acknowledge the receipt of download data packets 306 and 308 to the server. In the example of FIG. 3, data packets 308 and 310 transmitted over download stream 304 are delayed until first and second time markers 320 and 322, respectively, have passed. As a result, the effective downlink data rate of download stream 304 may be throttled so that the downlink data rate is a lower rate than can actually be supported. In such a case, the user may experience slower data downloads to the user device if the user device does not prioritize TCP ACK packets for uplink, as enabled herein in embodiments.

Accordingly, various embodiments are described herein for prioritizing the transmitting of data packets by a user device to enable increased download data rates, among other advantages. The following subsections each describe example embodiments for prioritizing the transmitting of data packets from a user device.

### A. Example Embodiments for Prioritizing Packets by Puncturing Sequence Numbers

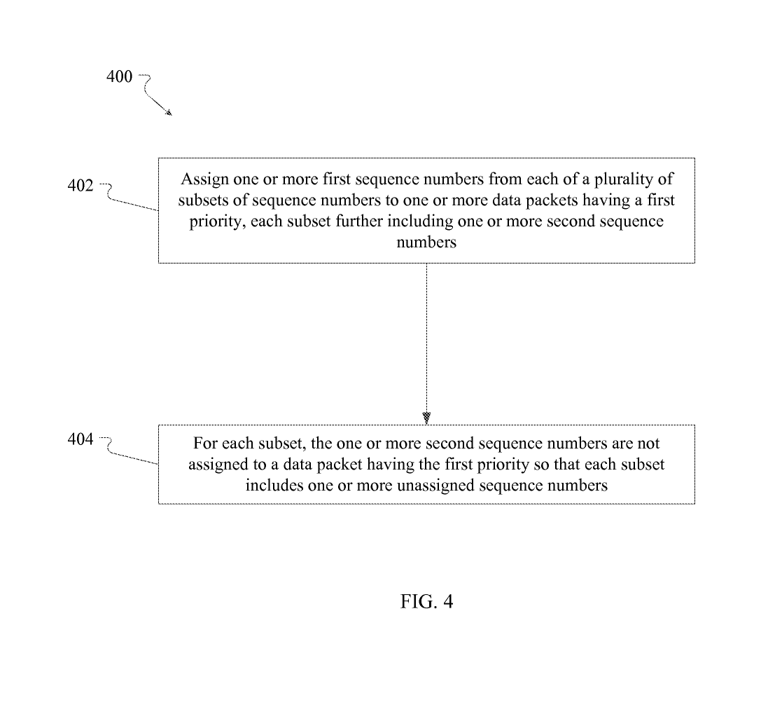

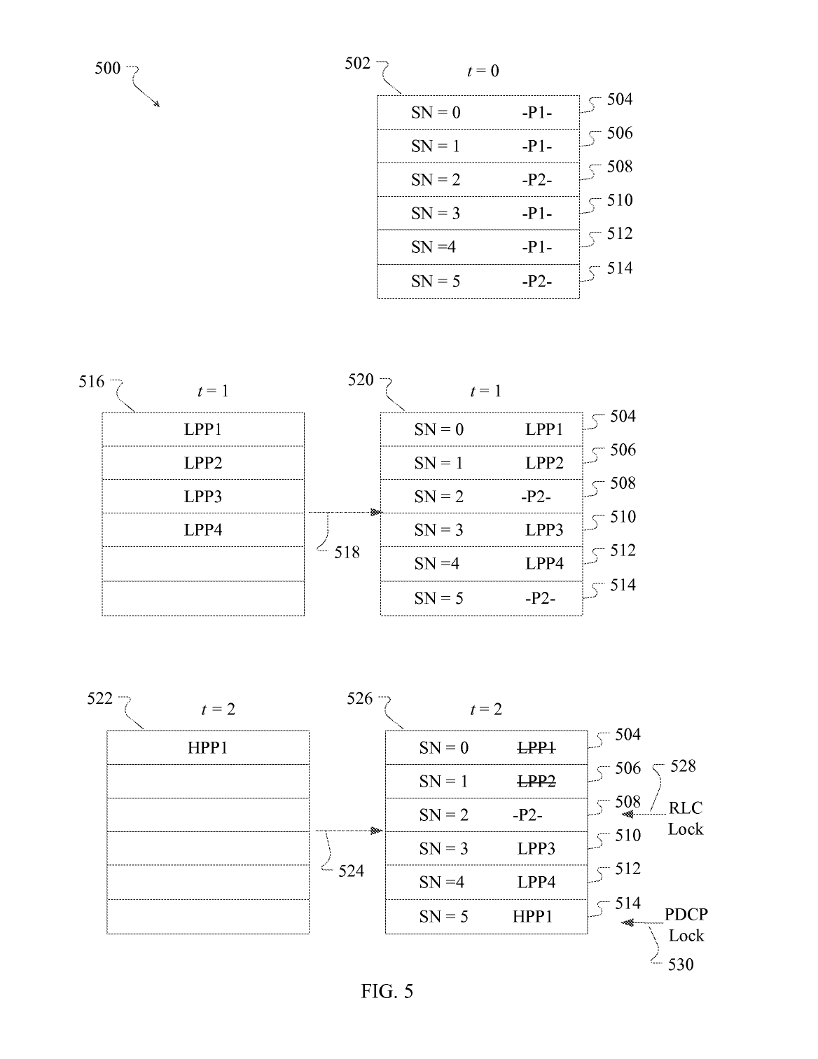

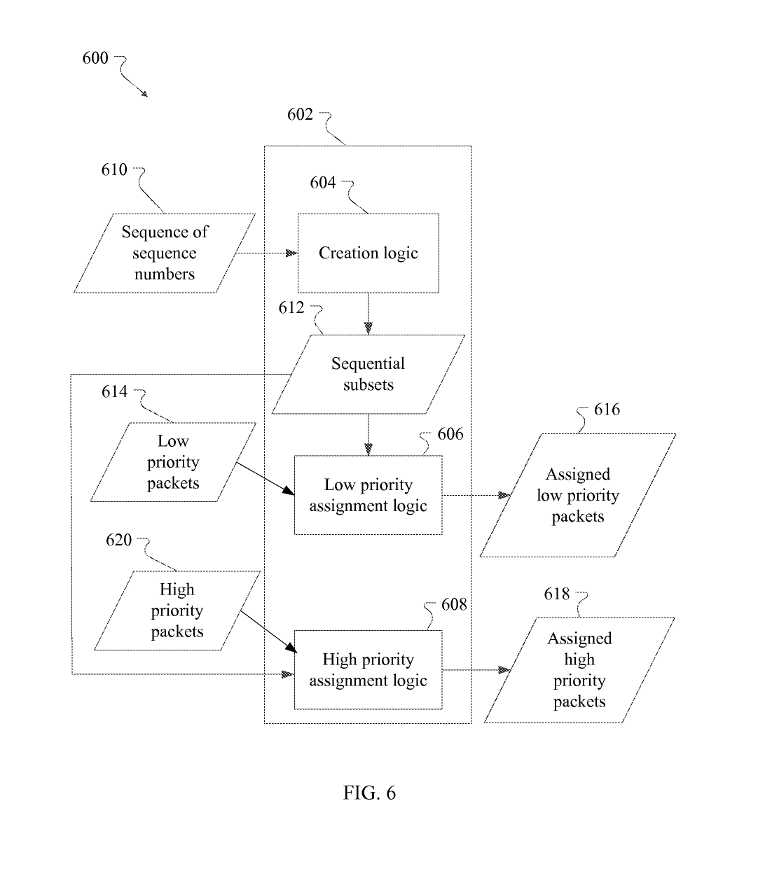

FIG. 4 depicts a flowchart 400 providing an example method of prioritizing packets by puncturing the sequence numbers, in accordance with an embodiment. In an embodiment, flowchart 400 may be performed by one of user devices 102, 104, 106, and 202. For illustrative purposes, flowchart 400 is described with respect to FIG. 5, which shows a block diagram view of a set of queues 500 being prioritized by puncturing sequence numbers, according to an example embodiment. Queues 500 of FIG. 5 shows queues at various point of time that are used in a user device to handle sequencing of data packets. For further illustrative purposes, flowchart 400 is also described with respect to FIG. 6. FIG. 6 shows a block diagram of a packet prioritization system 600, according to an example embodiment. In an embodiment, packet prioritization system 600 may be implemented in a user device (e.g., user device, 102, 104, 106, 202, etc.) and may operate according to flowchart 400. As shown in FIG. 6, packet prioritization system 600 includes an assignment logic 602, and assignment logic 602 includes a creation logic 604, a low priority assignment logic 606, and a high priority assignment logic 608. Further structural and operational embodiments will be apparent to persons skilled in the relevant art(s) based on the following discussion regarding flowchart 400.

It is noted that flowchart 400, queues 500, and packet prioritization system 600 are sometimes described as follows as if implemented in a PDCP layer of a protocol stack (e.g., PDCP layer 216 shown in FIG. 2). In PDCP embodiments, the data packets being handled may be referred to as “PDCP packets,” and their associated sequence numbers assigned in the PDCP layer may be referred to as “PDCP sequence numbers.” In other embodiments, flowchart 400, queues 500, and/or packet prioritization system 600 may be implemented elsewhere in a user device.

As shown in FIG. 4, flowchart 400 begins at step 402. In step 402, one or more first sequence numbers are assigned from each of a plurality of subsets of sequence numbers to one or more data packets having a first priority, each subset further including one or more second sequence numbers. For instance, creation logic 604 of FIG. 6 may receive a sequence of sequence numbers 610 and determine sequential subsets 612. For instance, creation logic 604 may determine a subset length in terms of a number of sequence numbers in each subset, and may categorize sequence numbers 610 into a series of subsets having the determined subset length, to generate sequential subsets 612. Low priority assignment logic 606 receives sequential subsets 612 and low priority packets 614 and generates assigned low priority packets 616. Low priority packets 614 may be received from an application, such as application 204 of FIG. 2. Assigned low priority packets 616 indicates a first (low) priority sequence number (of sequential subsets 612) assigned to each data packet of low priority packets 614.

For instance, referring to FIG. 5, a sequential subsets queue 502 may receive data packets with first PDCP sequence numbers and second PDCP sequence numbers, all of which are unassigned to packets at time t=0. In the example of FIG. 5, the first priority corresponds to a relatively low priority and the second priority corresponds to a relatively high priority (higher priority than the low priority). Sequential subsets queue 502 contains queue locations 504, 506, 508, 510, 512, and 514. Each of the queue locations of sequential subsets queue 502 is associated one of a sequence of PDCP sequence numbers, each denoted by “SN=”. The PDCP sequence numbers 0, 1, 2, 3, 4, and 5 are associated with queue locations 504, 506, 508, 510, 512, and 514, respectively. PDCP sequence numbers 0, 1, 3, and 4, associated with queue locations 504, 506, 510, and 512, are reserved for low priority PDCP packets, as represented by the notation “-P1-.” PDCP sequence numbers 2 and 5, associated with queue locations 508 and 514, are reserved for high priority PDCP packets, as represented by the notation “-P2-.” The unassigned high priority PDCP sequence numbers leave punctures (e.g., gaps in sequence numbers) in sequential subsets queue 502 that can be assigned to high priority PDCP packets received at a later time.

In FIG. 5, a sequential subsets queue 502 is present to store sequence numbers reserved for data packets generated by one or more applications in the user device. In the example of FIG. 5, sequential subsets queue 502 includes two sequential subsets of data packets, with queue locations 504, 506 and 508 representing a first sequential subset, and queue locations 510, 512, and 514 representing a second sequential subset. Each of the sequential subsets of sequential subset queue 502 contains at least one low priority PDCP sequence number and at least one high priority PDCP sequence number. For example, the first sequential subset contains two low priority PDCP sequence numbers (P1 associated with queue locations 504 and 506), and one high priority PDCP sequence number (P2 associated with queue location 508). Similarly, the second sequential subset contains two low priority PDCP sequence numbers (P1 associated with queue locations 510 and 512) and one high priority PDCP sequence number (P2 associated with queue location 514).

At time t=1, PDCP packets are received at a first receive queue 516 from one or more applications of the user device, to be transmitted from the user device. First receive queue 516 is depicted in FIG. 5 as containing four PDCP packets, depicted in order from first to last received: LPP1 (low priority packet 1), LPP2, LPP3 and LPP4. In the example of FIG. 5, LPP1, LPP2, LPP3, and LPP4 are all low priority PDCP packets, waiting to be assigned a PDCP sequence number.

During the t=1 timeframe, the PDCP packets received in first receive queue 516 are assigned PDCP sequence numbers of sequential subset queue 502 by an assignment process 518 (e.g., performed by low priority assignment logic 606 of FIG. 6), resulting in a first assignment queue 520. Assignment process 518 is represented by a dotted arrow from first receive queue 516 to first assignment queue 520. First assignment queue 520 represents sequential subset queue 502 with low priority PDCP packets assigned to low priority PDCP sequence numbers. In the example of FIG. 5, queue locations 504, 506, 510, and 512 are assigned to low priority PDCP packets LPP1, LPP2, LPP3, and LPP4.

Referring back to FIG. 4, in step 404, for each subset, the one or more second sequence numbers are not assigned to a data packet having the first priority so that each subset includes one or more unassigned sequence numbers. As described above with respect to FIG. 6, low priority assignment logic 606 receives low priority packets 614 and sequential subsets 612, and generates assigned low priority packets 616. However, assigned low priority packets 616 does not include any high priority sequence numbers (second sequence numbers) of sequential subsets 612.

For instance, referring to the example of FIG. 5, only the low priority PDCP sequence numbers from sequential subset queue 502 are assigned in first assignment queue 520 at t=1. Queue locations 504, 506, 510, and 512, which are associated with low priority sequence numbers, are all assigned to a low priority PDCP packet. Queue locations 508 and 514, each of which is associated with a high priority sequence number, have not been assigned to a low priority PDCP packet.

Thus, according to flowchart 400, one or more sequence numbers, in each sequential subset of sequence numbers, are not assigned to data packets, but are instead held in reserve, even while other preceding and subsequent sequence numbers are assigned to data packets. These reserved sequence numbers may be later assigned to high priority data packets, such as TCP ACK packets. For instance, a reserved sequence number may be assigned to a high priority data packet at a time that the high priority data packet arrives (e.g., at the PDCP layer). The high priority data packet may then be transmitted from the user device in sequence with the other surrounding data packets having assigned sequence numbers, in an order dictated by the assigned sequence numbers, even though some of those other surrounding data packets had their sequence numbers assigned earlier (in step 402).

For instance, in an embodiment, flowchart 400 may include the step of assigning at least one of the second sequence numbers to at least one packet having a second priority, where the second priority is greater than the first priority. For example, in FIG. 6, high priority assignment logic 608 of assignment logic 602 may receive sequential subsets 612 and high priority packets 620, and may produce assigned high priority packets 618. High priority packets 620 may be received from an application, such as application 206 of FIG. 2, or from TCP layer 210 of FIG. 2. Assigned high priority packets 618 indicates a second priority sequence number (of sequential subsets 612) assigned to each data packet of high priority packets 620.

In the example of FIG. 5, in subset queue 502, the sequence numbers at queue locations 508 and 514 are high priority PDCP sequence numbers, as denoted by the label “-P2-”. A high priority PDCP packet may subsequently be received at a second receive queue 522 at time t=2, shown as HPP1 (high priority packet 1). The assignment of HPP1 from second receive queue 522 to a high priority PDCP sequence number is represented by a second packet assignment process 524 (e.g., performed by high priority assignment logic 608 of FIG. 6), represented by a dotted arrow from second receive queue 522 to a second assignment queue 526. For instance, HPP1 may be assigned queue location 508 of second assignment queue 526. Alternatively, if queue location 508 has already been allocated to another high priority packet or is locked, HPP1 may be assigned queue location 514 as shown in FIG. 5.

For instance, in a further example, it is possible to determine that a subset of sequence numbers is locked for transmission from a user device to a base station. A sequence number may be locked because the packet previously assigned to the locked sequence number was sent or is already in the process of transmitting, or the locked sequence number may have been reached for transmission with no packet assigned, and may therefore be skipped.

Referring to the example of FIG. 5, second packet assignment process 524 may determine whether a RLC protocol layer has a lock on any of the queue locations in second assignment queue 526 before determining which high priority PDCP sequence number to assign to high priority PDCP packet HPP1. An RLC lock 528 at sequence number 2, queue location 508, indicates that the RLC layer either has already sent or is sending the PDCP packet assigned to queue location 508 to the physical layer next. To avoid this problem, in an embodiment, only sequence numbers greater than the sequence number that the RLC layer has locked may be assigned by the PDCP layer. The next unassigned high priority PDCP sequence number (e.g., sequence number 5 at queue location 514 in FIG. 5), may therefore be assigned to packet HPP1. A PDCP lock 530 may be placed on queue location 514 when second packet assignment process 524 assigns HPP1 to sequence number 5.

The difference between the sequence number positions in the assignment queue to which the RLC lock and the PDCP lock respectively point may be carefully tuned for performance. In one embodiment, the RLC lock and the PDCP lock may be tuned so that the RLC layer is able to serve any uplink allocation provided by the base station without interrupting the processing of PDCP packets that have been assigned to punctured sequence numbers. In another embodiment, tuning the RLC lock and the PDCP lock may depend on the estimated security processing time of the PDCP layer, which can vary from one implementation to another, as will be understood by those skilled in the art(s). The RLC lock and the PDCP lock may also be set to point at the same sequence numbers so that the MAC would occasionally be forced to send only padding bits in response to an uplink grant in order to avoid sending out of order PDCP sequence numbers, as will be understood by those skilled in the relevant art(s).

It will be recognized that FIG. 5 shows merely one example implementation of prioritization of packets using PDCP by puncturing sequence numbers for illustrative purposes and is not intended to be limiting.

In a further example, each sequential subset may include a single first sequence number and a single second sequence number. In such an example, each subset will include exactly one high priority sequence number and one low priority sequence number. Such an implementation causes low priority packets and high priority packets to be alternated with each other for transmission.

In a further example, each subset may include a single first sequence number and a plurality of second sequence numbers. In such an example, each subset will include one low priority sequence number and two or more high priority sequence numbers. Such an implementation may cause one low priority packet to be transmitted for one or more high priority packets that is/are transmitted.

In a further example, one or more second sequence numbers may be assigned to respective packets based on an uplink data rate and a downlink rate. The uplink rate is the rate at which a packet having the second priority is to be transmitted from the user device to the base station. The downlink data rate is the rate at which downlink packets are transmitted from the base station to the user device. For example, in FIG. 3, upload stream 302 has an uplink data rate of 50 Mbit/s and download stream 304 has a downlink data rate of 100 Mbit/s. With respect to TCP ACK packets, the higher the downlink data rate, the more frequent it may be desired to send out TCP ACKs for downloaded data (so that further data packets may be downloaded). Thus, with a higher downlink data rate, it may be desired to reserve a higher number of high priority packets relative to the number of low priority packets so that the TCP ACKs may be sent more frequently.

For instance, the number of second priority (high priority) sequence numbers may be based on a size of the packets that have the first priority (low priority) in the subset. For example, if the low priority packets tend to be larger sized, a greater number of high priority sequence numbers may be reserved. If the low priority packets tend to be smaller sized, a lower number of high priority sequence numbers may be reserved.

Furthermore, the number of second sequence numbers that are selected for a particular subset may be based on a type of the packets that have the first priority in the subset. For example, the number of queue locations reserved for high priority PDCP packets, or punctures, denoted by “-P2-” in subset queue 502 (FIG. 5) may be based on the type of each of the low priority PDCP packets received (e.g., image file data, video file data, Facebook updates, etc.). If the type of low priority packets (e.g., uploading an image) indicates that the download rate would benefit significantly from prioritizing high priority PDCP packets, a higher number of second sequence numbers may be reserved in each subset for high priority packets. If the type of low priority packets indicates that the download rate would not benefit from prioritizing high priority PDCP packets, a lower number of second sequence numbers may be reserved in each subset for high priority packets.

### B. Example Embodiments for Prioritizing Packets by Encrypting Packets Corresponding to an Uplink Allocation

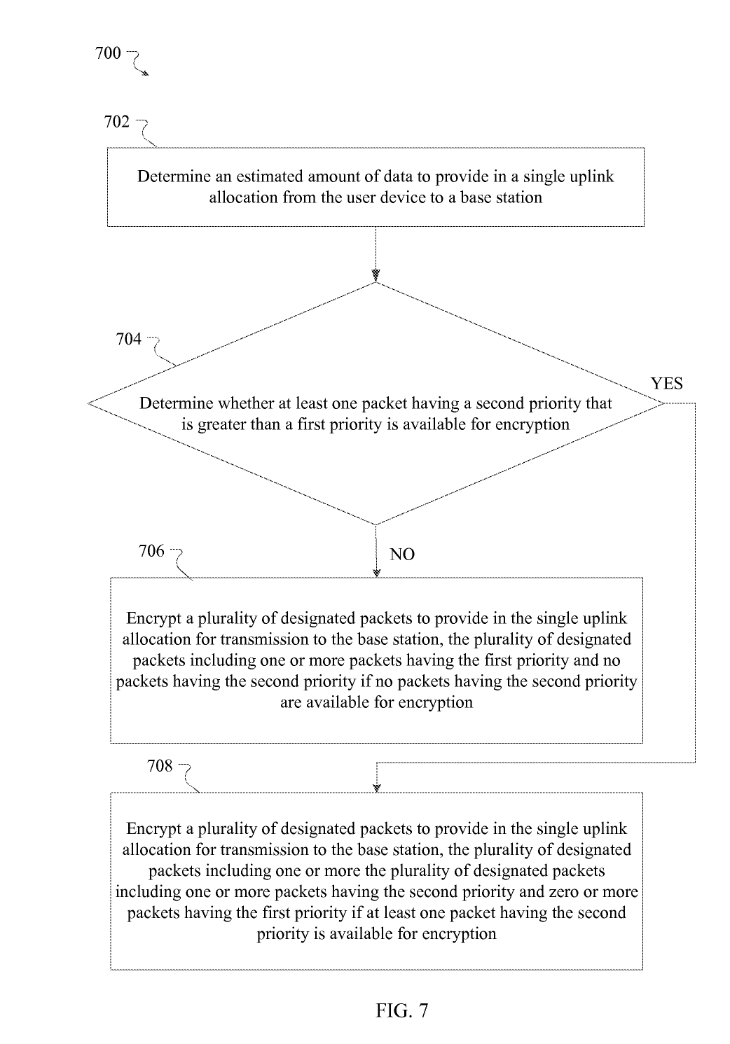

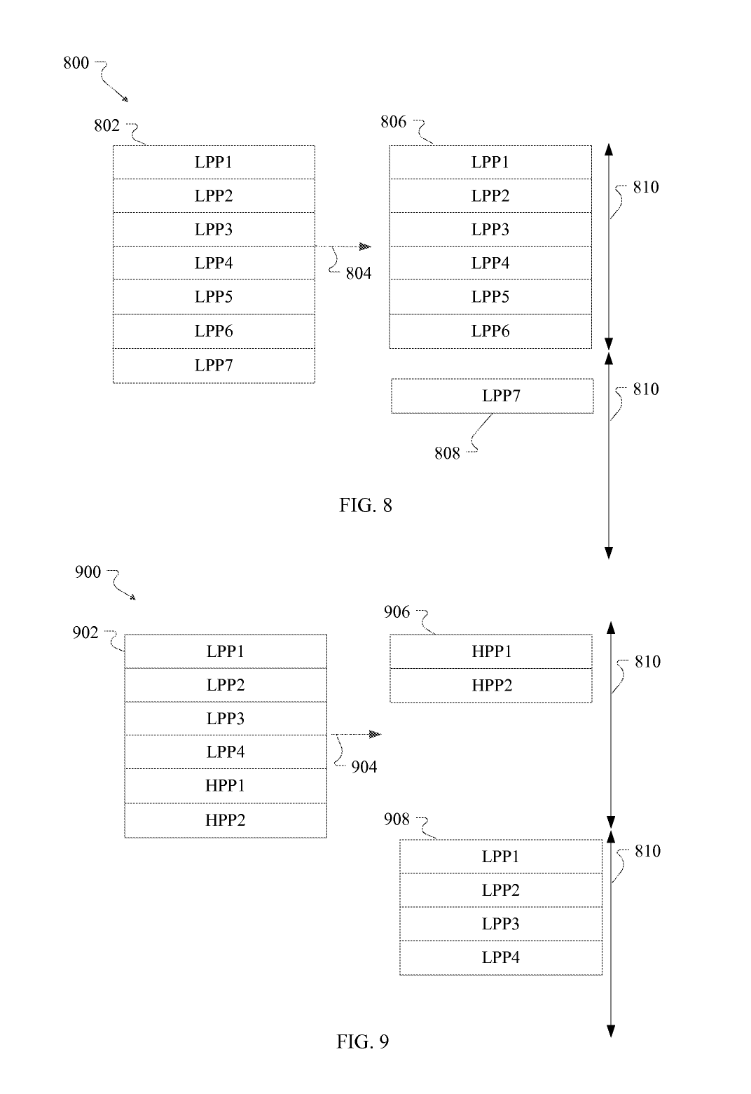

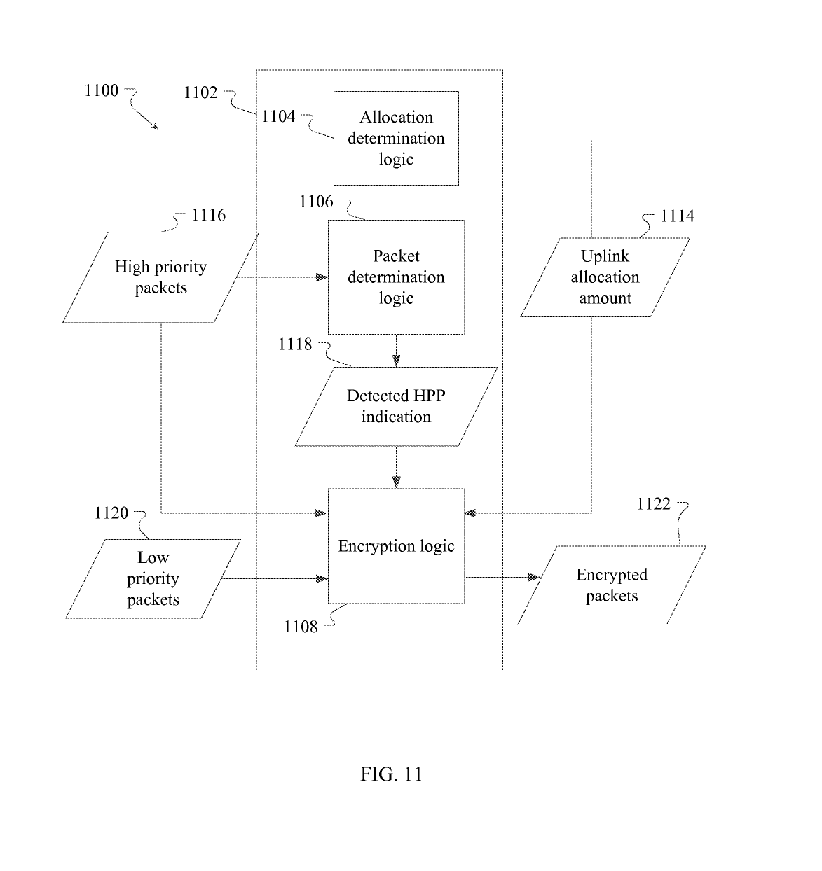

FIG. 7 shows a flowchart 700 providing an example method of prioritizing packets by encrypting a quantity of data that corresponds to a single allocation, in accordance with embodiments described herein. Flowchart 700 may be performed by one of user devices 102, 104, 106, and 202 of FIGS. 1 and 2, for example. For illustrative purposes, flowchart 700 is described with respect to FIGS. 8-11. FIGS. 8-10 show examples of queues containing packets being prioritized by encrypting a quantity of data that corresponds to a single uplink allocation, according to embodiments. FIG. 11 shows a block diagram of a packet prioritization system 1100, according to an example embodiment. In an embodiment, packet prioritization system 1100 may be implemented in a user device (e.g., user device, 102, 104, 106, 202, etc.) and may operate according to flowchart 700. In the example of FIG. 11, packet prioritization system 1100 includes an encrypting and storage logic 1102. Encrypting and storage logic 1102 includes allocation determination logic 1104, a packet determination logic 1106, and an encryption logic 1108. Further structural and operational embodiments will be apparent to persons skilled in the relevant art(s) based on the following discussion regarding flowchart 700. Note that not all steps shown in flowchart 700 need to be performed in all embodiments. Moreover, additional and/or alternative steps that are not shown may be performed in flowchart 700.

As shown in FIG. 7, flowchart 700 begins at step 702. In step 702, an estimated amount of data to provide in a single uplink allocation from the user device to a base station is determined. An uplink allocation is the amount of data that can be sent in one upload transmission time interval (TTI) from the user device to the base station, or one frame. For example, with reference to FIG. 2, user device 202 sends and receives frames 228 to and from to base station 236 via receiver/transmitters 230 and 232. The estimated amount of data in a single uplink allocation is the amount of data in one frame 228 that user device 202 can send to base station 236 in one TTI. For example, under the LTE standard a category 4 user device uplink allocation can contain from 8 B (bytes) to 6 kB (kilobytes) of data. Referring to FIG. 11, in an embodiment, allocation determination logic 1104 may be configured to determine the amount of data to include in the uplink allocation. In one embodiment, the amount of data in a single uplink allocation may be estimated by allocation determination logic 1104 based on a difference between an amount of power that the base station transmits to the user device and an amount of power that the user device receives from the base station. As shown in FIG. 11, allocation determination logic 1104 generates uplink allocation amount 1114, which includes the estimated amount of data for a single uplink allocation.

For instance, allocation determination logic 1104 may receive a power indicator at the user device in a communication signal from the base station. The power indicator may specify an amount of power at which the base station transmits to the user device. Allocation determination logic 1104 may also determine or measure (e.g., by interacting with the physical layer) the amount of power that the user device receives from the base station at the user device.

In an embodiment, allocation determination logic 1104 may calculate the intensity of user device transmit power for each of several different data allocation sizes. Allocation determination logic 1104 may next determine the minimum user device transmit power value needed to provide the maximum data allocation size. The maximum data allocation size may then be used to determine the largest allocation that the base station can grant the user device. Those skilled in the art(s) will recognize that the user device transmit power may be determined based on the power indicator at the user device from the base station, the data allocation size, and/or other additional parameters (e.g., see 5.1.1.1 of 3GPP TS 36.213).

In an embodiment, allocation determination logic 1104 may determine the minimum user device transmit power value needed to provide the maximum data allocation size at a target error rate. The maximum data allocation size may then be used to determine the largest allocation that the base station can grant the user device. In other words, the estimated amount of data may be the approximated maximum amount of data that the base station is capable of receiving from the user device in the single uplink allocation based on a user device transmit power value and the error rate associated with transmission of the plurality of designated packets from the user device to the base station. For example, the transmission of designated packets at a particular user device transmit power value may be associated with an error rate of 20%, meaning that 20% of the packets sent from the user device may not arrive at the base station.

In an embodiment, this estimated amount of data may be considered to be an approximated maximum amount of data that the base station is capable of receiving from the user device in the single uplink allocation. Using the maximum amount of data may allow the user device to uplink as many packets to the base station as possible, sending uplink data packets at as fast a rate as is possible in the particular current environment.

Referring back to FIG. 7, in step 704, it is determined whether at least one packet having a second priority that is greater than a first priority is available for encryption. The second priority corresponds to a relatively high priority, and the first priority corresponds to a relatively low priority. If one or more packets having the second priority are available for encryption, operation proceeds to step 708. If one or more packets having the second priority are not available for encryption, operation proceeds to step 706.

For example, in an embodiment, packet determination logic 1106 receives high priority packets 1116 when one or more high priority packets are present. If high priority packets are present, packet determination logic 1106 generates a detected HPP indication 1118 to indicate that high priority packets are present.

FIGS. 8-10 are referenced to illustrate operation of flowchart 700 and packet prioritization system 1100. FIGS. 8-10 shows data packet queues 800, 900, and 1000, respectively. Queue 800 includes an available packet queue 802 a first designated allocation 806, and a second designated allocation 808. Queue 900 includes an available packet queue 902, a first designated allocation 906, and a second designated allocation 908. Queue 1000 includes available packet queue 902, a first designated allocation 1006, and a second designated allocation 1008. In each of FIGS. 8-10, an estimated amount of data in a single uplink allocation 810 is represented by a pair of end-to-end vertical double sided arrows.

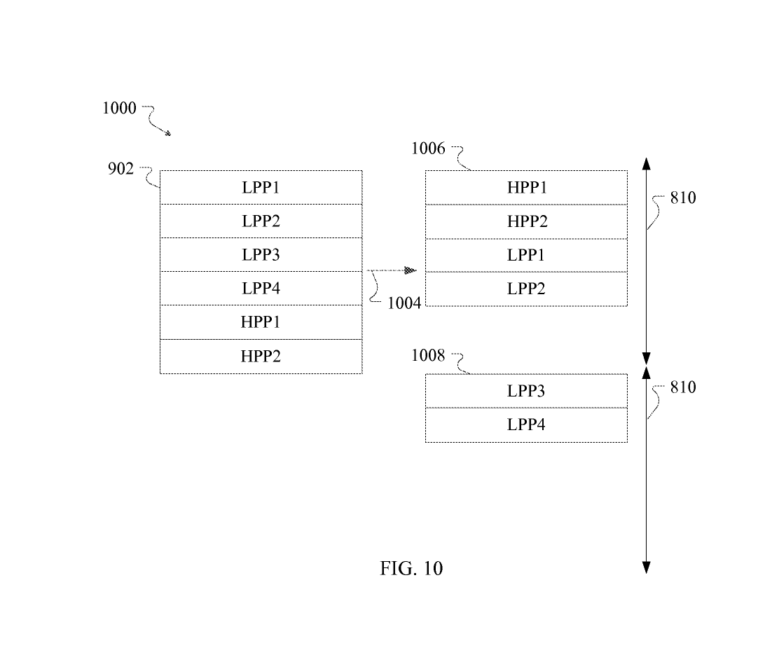

An available packet queue 802 of FIG. 8 and an available packet queue 902 of FIGS. 9 and 10 represent PDCP packets that are available for encryption. Packet queue 802 of FIG. 8 contains seven packets, LPP1, LPP2, LPP3, LPP4, LPP5, LPP6, and LPP7, each of which are low priority PDCP packets. In FIG. 8, no high priority PDCP packets are available for encryption. Packet queue 902 of FIGS. 9 and 10 contains six packets, LPP1, LPP2, LPP3, LPP4, HPP1, and HPP2. LPP1, LPP2, LPP3, and LPP4 are lower priority PDCP packets, and HPP1 and HPP2 are high priority PDCP packets. Thus, no high priority packets are determined to be available for encryption in packet queue 802 of FIG. 8 (e.g., by packet determination logic 1106 of FIG. 11), and high priority packets are determined to be available for encryption in available packet queue 902 of FIGS. 9 and 10.

Referring back to FIG. 7, in step 706, a plurality of designated packets is encrypted to provide in the single uplink allocation for transmission to the base station, the plurality of designated packets including one or more packets having the first priority and no packets having the second priority if no packets having the second priority are available for encryption. Flowchart 700 is complete after step 706.

For example, with reference to FIG. 11, encryption logic 1108 may receive detected HPP indication 1118, low priority packets 1120, and uplink allocation amount 1114. When step 706 is received, detected HPP indication 1118 indicates that no second priority packets are available. As such, encryption logic 1108 generates encrypted packets 1122 to include encrypted versions of the packets included in low priority packets 1120, up to an amount of data bounded by uplink allocation amount 1114. Thus, encrypted packets 1122 may include one or more low priority packets, and include no high priority packets.

In the case where encryption logic 1108 encrypts a single packet, encryption logic 1108 may encrypt an entire packet up to the size of uplink allocation amount 1114. If a packet size is greater than uplink allocation amount 1114, then encryption logic 1108 may encrypt the packet using the entire uplink allocation amount 1114 to send the first part of the packet, sending the rest of the packet in later allocation(s). For example if the uplink allocation amount is 1000 bytes and a single packet to be encrypted in an uplink allocation is 1500 bytes long, encryption logic 1108 may encrypt 1000 bytes in a first allocation, and 500 bytes in a later allocation.

As described above, FIG. 8 shows available packet queue 802 containing no high priority PDCP packets available for encryption. Available packet queue 802 includes only low priority PDCP packets, which are encrypted via an encryption process 804 (e.g., performed by encryption logic 1108), represented by a dotted arrow in FIG. 8. Encryption process 804 generates a first designated allocation 806. First designated allocation 806 contains encrypted low priority PDCP packets LPP1, LPP2, LPP3, LPP4, LPP5, and LPP6. As indicated by single uplink allocation 810 shown next to first designated allocation 806, LPP1, LPP2, LPP3, LPP4, LPP5, and LPP6 are encrypted to fill first designated allocation 806 (enough space is not present to include LLP7). Encryption process 804 may encrypt LPP7 into a second designated allocation 808 at a later time.

Referring back to FIG. 7, in step 708, a plurality of designated packets is encrypted to provide in the single uplink allocation for transmission to the base station, the plurality of designated packets including one or more the plurality of designated packets including one or more packets having the second priority and zero or more packets having the first priority if at least one packet having the second priority is available for encryption. Flowchart 700 is complete after step 708.

For example, with reference to FIG. 11, encryption logic 1108 may receive detected HPP indication 1118, high priority packets 1116, low priority packets 1120, and uplink allocation amount 1114. When step 708 is received, detected HPP indication 1118 indicates that one or more second priority packets are available. As such, encryption logic 1108 generates encrypted packets 1122 to include encrypted versions of one or more of the packets included in high priority packets 1116, and optionally one or more of the packets included in low priority packets 1120, up to an amount of data bounded by uplink allocation amount 1114. Thus, encrypted packets 1122 may include one or more high priority packets, and may include zero or more low priority packets.

Referring to the example of FIG. 9, available packet queue 902 is encrypted via an encryption process 904 (e.g., performed by encryption logic 1108), as represented by a dotted arrow in FIG. 9. Encryption process 904 generates a first designated allocation 906. First designated allocation 906 contains encrypted higher priority PDCP packets HPP1 and HPP2. As indicated by single uplink allocation 810 shown next to first designated allocation 906, higher priority PDCP packets HPP1 and HPP2 do not completely fill first designated allocation 906. As such, encryption process 904 may encrypt one or more of LPP1, LPP2, LPP3, and LPP4 into first designated allocation 906 (as bounded by single uplink allocation 810), and may encrypt any of LPP1, LPP2, LPP3, and LPP4 not included in first designated allocation 906 into a second designated allocation 908 at a later time (as bounded by a single uplink allocation at that time). Second designated allocation 908 may be a next sequential uplink allocation following first designated allocation 906.

For instance, in the alternative example of FIG. 10, available packet queue 902 is encrypted via an encryption process 1004 (e.g., performed by encryption logic 1108), as represented by a dotted arrow in FIG. 10. Encryption process 1004 generates a first designated allocation 1006. First designated allocation 1006 includes encrypted higher priority PDCP packets HPP1 and HPP2 and lower priority PDCP packets LPP1 and LPP2 (as bounded by single uplink allocation 810). In this example, encryption process 1004 may encrypt LPP3 and LPP4 into a second designated allocation 1008 at a later time.

It is noted that in FIG. 10, as indicated by single uplink allocation 810 shown next to first designated allocation 1006, PDCP packets HPP1, HPP2, LPP1 and LPP2 do not completely fill first designated allocation 1006. As such, encryption process 1004 may fill first designated allocation 1006 with additional high and/or low priority PDCP packets, such as low priority packets LPP3 and LPP4.

Thus, according to flowchart 700, a single link allocation may be filled with lower priority packets when no higher priority packets are available, but when higher priority packets are available, such higher priority packets may be used to fill the single link allocation as much as possible (with any remaining space filled with lower priority packets). This helps to ensure that higher priority packets are transmitted from a user device at a higher rate than according to conventional techniques. When the higher priority packets include TCP ACK packets, this enables as many TCP ACK packets as are available to be used to fill the single link allocation (with other high priority packets, and optionally low priority packets, used to fill any remaining allocation space). As such, a server transmitting data packets to the user device will receive the TCP ACK packets at a higher rate, which will enable a higher download data rate for data packets from the server to the user device, as described above.

Any number of the available second priority packets may be encrypted and included in a particular uplink allocation, including one of the second priority packets, all of the second priority packets, or any number in between. Furthermore, an order in which packets having the first priority and packets having the second priority are encrypted into an available uplink allocation may be based on the order in which the packets are received, based on at least one of an uplink data rate with which packets are transmitted from the user device to the base station or a downlink data rate with which downlink packets are transmitted from the base station to the user device, based on one or more types associated with the packets having the first priority and/or the second priority, and/or based on other criteria. For example, one or more high priority packet types may include TCP ACK packets. The high priority packet types may be used to determine whether packets prioritized or encrypted in a manner that preserves the order in which packets are received.

### C. Example Embodiments for Prioritizing Packets by Encrypting Higher Priority Packets When Received and Re-Encrypting Unsent Lower Priority Packets

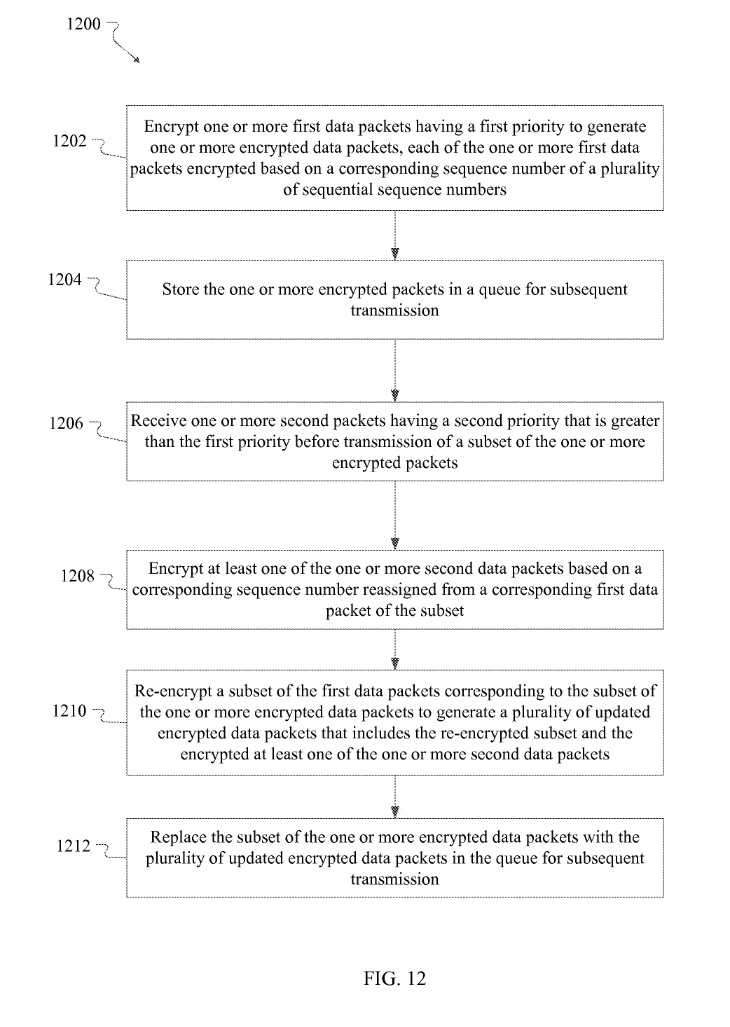

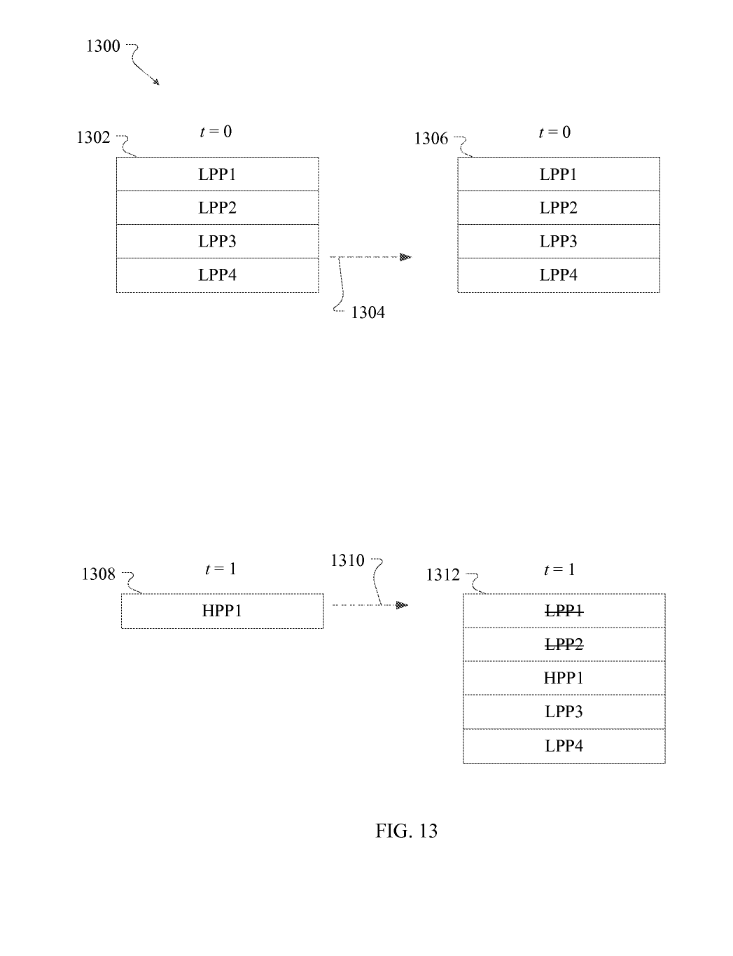

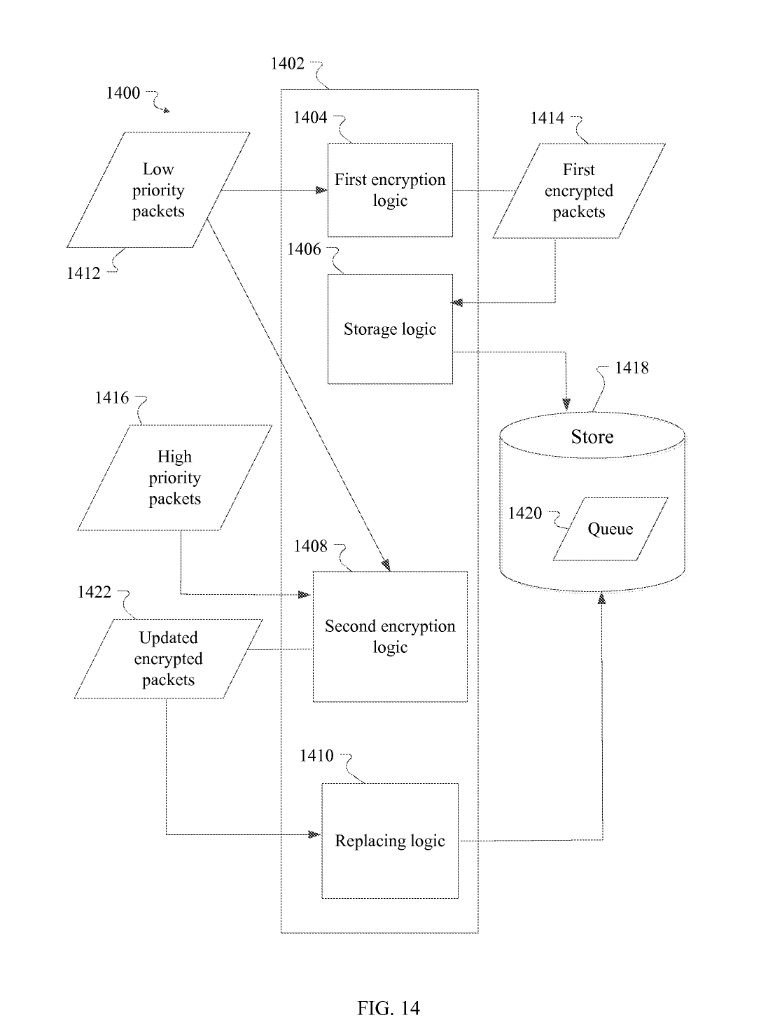

FIG. 12 shows a flowchart 1200 of an example method of prioritizing newly received higher priority packets in accordance with embodiments described herein. Flowchart 1200 may be performed by user devices 102, 104, 106, or 202 of FIGS. 1 and 2, for example. For illustrative purposes, flowchart 1200 is described with respect to FIGS. 13 and 14. FIG. 13 shows a block diagram view of data packet queues 1300 containing packets being prioritized by encrypting higher priority packets when received and re-encrypting unsent lower-priority packets waiting in the queue, according to embodiments. FIG. 14 shows a block diagram of a packet prioritization system 1400, according to an example embodiment. Packet prioritization system 1400 is configured to prioritize packets by encrypting higher priority packets when received and re-encrypting unsent lower-priority packets waiting in the queue. In an embodiment, packet prioritization system 1400 may be implemented in a user device (e.g., user device, 102, 104, 106, 202, etc.) and may operate according to flowchart 1200. As shown in FIG. 14, system 1400 includes a re-encrypting and storing queue logic 1402, which includes a first encryption logic 1404, a storage logic 1406, a second encryption logic 1408, and a replacing logic 1410. Further structural and operational embodiments will be apparent to persons skilled in the relevant art(s) based on the following discussion regarding flowchart 1400.

As shown in FIG. 12, flowchart 1200 begins at step 1202. In step 1202, one or more first data packets having a first priority are encrypted to generate one or more encrypted data packets, each of the one or more first data packets encrypted based on a corresponding sequence number of a plurality of sequential sequence numbers. For example, first encryption logic 1404 receives low priority packets 1412. First encryption logic 1404 assigns sequence numbers to the data packets of low priority packets 1412, and encrypts the data packets of low priority packets 1412 at least based on their corresponding sequence numbers to generate first encrypted packets 1414.

For instance, with reference to the example of FIG. 13, at time t=0, a first receive queue 1302 receives PDCP packets LPP1, LPP2, LPP3, and LPP4, all of which are relatively low priority PDCP packets. A first encryption process 1304 (e.g., performed by first encryption logic 1404), represented by a dotted arrow pointing from first receive queue 1302 to a first encrypted packet queue 1306, assigns sequence numbers 0-3 to PDCP packets LPP1, LPP2, LPP3, and LPP4 of first receive queue 1302. First encryption process 1304 encrypts PDCP packets LPP1, LPP2, LPP3, and LPP4 of first receive queue 1302 in part by receiving sequence numbers 0-3, and encrypting each of PDCP packets LPP1, LPP2, LPP3, and LPP4. First encryption process 1304 may then use each PDCP packet's corresponding sequence number to feed the packets into the encryption process on a first-come-first-serve basis. As such, sequence numbers 0-3 are claimed by the encrypted versions of PDCP packets LPP1, LPP2, LPP3, and LPP4, and the encrypted versions of PDCP packets LPP1, LPP2, LPP3, and LPP4 are designed to be transmitted from the user device in the order of their sequence numbers.

In step 1204, the one or more encrypted packets may be stored in a queue for subsequent transmission. For example, storage logic 1406 of FIG. 14 may receive first encrypted packets 1414 generated by first encryption logic 1404, and may store first encrypted packets 1414 in a queue 1420 in a store 1418 (e.g., a database or other data storage structure stored in storage, such as a memory, a hard drive, etc.). In an embodiment, store 1418 may be associated with RLC/MAC layer 222 of FIG. 2, which may store the encrypted data packets in queue 1420 prior to transmitting them from user device 202 via physical layer 226.

Continuing the example of FIG. 13, first encryption process 1304 may store the encrypted packets of first receive queue 1302 (e.g., encrypted versions of LPP1, LPP2, LPP3, and LPP4) in first encrypted packet queue 1306.

In step 1206, one or more second packets are received having a second priority that is greater than the first priority before transmission of a subset of the one or more encrypted packets. For example, referring to FIG. 14, high priority packets 1416 may be received. High priority packets 1416 may include one or more high priority packets.

Continuing the example of FIG. 13, a second receive queue 1308 may receive packet HPP1 at t=1, which is a high priority packet.

In step 1208, at least one of the one or more second data packets is encrypted based on a corresponding sequence number reassigned from a corresponding first data packet of the subset. For example, as shown in FIG. 14, second encryption logic 1408 may receive low priority packets 1412 and high priority packets 1416. Second encryption logic 1408 may determine the sequence numbers previously assigned to the encrypted versions of low priority packets 1412 in queue 1420 that have not yet been transmitted, and reuse those sequence numbers, encrypting and assigning the subsequent reused sequence numbers to at least one of high priority packets 1416.

In step 1210, a subset of the first data packets corresponding to the subset of the one or more encrypted data packets is re-encrypted to generate a plurality of updated encrypted data packets that includes the re-encrypted subset and the encrypted at least one of the one or more second data packets. Second encryption logic 1408 is configured to first assign the reused sequence numbers in sequence to high priority packets 1416 and then to low priority packets 1412 until those reused sequence numbers are used up. Second encryption logic 1408 next assigns unused subsequent sequence numbers to high priority packets 1416 and low priority packets 1412 in a normal fashion. Second encryption logic 1408 then encrypts the data packets of high priority packets 1416 and low priority packets 1412, at least based on their corresponding sequence numbers, to generate updated encrypted packets 1422.

In step 1212, the subset of the one or more encrypted packets is replaced with the plurality of updated encrypted packets in the queue for subsequent transmission. For example, replacing logic 1410 receives updated encrypted packets 1422 and updates queue 1420 inside store 1418 by replacing encrypted packets in queue 1420 with encrypted packets of updated encrypted packets 1422 having the same assigned sequence number.

Continuing the example of FIG. 13, high priority packet HPP1 of second receive queue 1308 is encrypted by a second encryption process 1310 into a second encryption packet queue 1312, using a sequence number claimed from LPP3, which is a previously encrypted low priority packet. Second encrypted packet queue 1312 incorporates changes to the first packet queue 1306 at a later time, t=1. The packets LPP1 and LPP2 appear with a strikeout in second encrypted packet queue 1312, representing that LPP1 and LPP2 have either been either been sent, or are in the process of being sent. As such, the sequence numbers for packets LPP1 and LPP2 could not be reassigned. Second encryption process 1310 encrypts high priority packet HPP1 from second receive queue 1308 using the sequence number used by the previously encrypted version of LPP3, because LPP3 is a low priority packet, and was not yet in the process of being transmitted. Thus, HPP1 is inserted in second encrypted packet queue 1312 in the sequence number location where LPP3 was previously located (as shown in first encrypted packet queue 1306). Second encryption process 1310 also re-encrypts LPP3 and any other lower priority packets that have not yet been sent or are subsequently received, such as low priority packet LPP4. Re-encrypted packet LPP3 and newly encrypted packet LPP4 are inserted in second encrypted packet queue 1312 in their corresponding sequence number locations.

### D. Enabling Example Embodiments for Prioritizing Packets

The embodiments for packet prioritization may each be used singly in a user device, or one or more packet prioritization embodiments may be combined and/or used simultaneously in a user device. Furthermore, according to embodiments, the packet prioritization techniques described herein may be constantly functional in a user device, or may be enabled and/or disabled at various times. For instance, in an embodiment, a packet prioritization embodiment may be enabled when the following conditions are met: (a) the user device (e.g., a modem thereof) detects the presence of high priority packet traffic, (b) the user device detects the need to perform prioritization (e.g., based on the downlink packet traffic type and/or traffic volume, the uplink traffic type/mix, etc.), and (c) the current uplink/downlink performance is subpar (e.g., the uplink and/or downlink data rate(s) are below a predetermined threshold rate, an uplink-to-downlink data rate ratio is above or below a predetermined threshold, etc.). Otherwise, the packet prioritization embodiments may remain disabled to ensure efficient usage of sequence numbers, to ensure low complexity PDCP/RLC execution, etc.

### D. Further Example Advantages of Embodiments for Prioritizing Packets

One or more embodiments described herein may have the following further example advantages:

With ACK prioritization, a peak link layer downlink throughput rate can be achieved for bidirectional TCP in the case of an asymmetric communication channel. An LTE channel tends to be asymmetric in most cell locations due to the difference in downlink and uplink transmit powers of the base station and user device.

For interactive traffic, such as webpage browsing, the webpage will load much faster for bidirectional TCP.

Push notifications for real time services can be delivered faster with ACK prioritization for bidirectional TCP. Most mobile platforms rely on push notifications to provide real time services to users. Embodiments enable better performance for push notifications.

High priority packets prioritized over previously received low priority packets can be transmitted in a manner that avoids out of sequence PDCP packet sequence numbers. When they occur, out of sequence packet sequence PDCP numbers may be dropped by a base station.

When existing uplink PDCP packets have been stored in a queue ahead of an uplink grant to the user device from the base station, the PDCP can respond quickly to the uplink grant without the need to fetch, assign serial numbers to, and encrypt packets. A quick response by the PDCP may ensure that the RLC-PHY time delays for packets are minimized. Processor idle times may also be utilized to perform security processing, thus achieving a higher level of work conservation.

The embodiments described herein are compatible with the 3GPP, or LTE specification.

### III. Other Example Embodiments

Transmission control protocol (TCP) layer 210, selective-prioritization enabled PDCP layer 216, radio link control/medium access control (RLC/MAC) layer 222, physical layer 226, assignment logic 602, creation logic 604, low priority assignment logic 606, high priority assignment logic 608, encrypting and storage logic 1102, allocation determination logic 1104, packet determination logic 1106, encryption logic 1108, re-encrypting and storing queue logic 1402, first encryption logic 1404, storage logic 1406, second encryption logic 1408, replacing logic 1410, flowchart 400, flowchart 700, and/or flowchart 1200 may be implemented in hardware, or any combination of hardware with software and/or firmware. For example, transmission control protocol (TCP) layer 210, selective-prioritization enabled PDCP layer 216, radio link control/medium access control (RLC/MAC) layer 222, physical layer 226, assignment logic 602, creation logic 604, low priority assignment logic 606, high priority assignment logic 608, encrypting and storage logic 1102, allocation determination logic 1104, packet determination logic 1106, encryption logic 1108, re-encrypting and storing queue logic 1402, first encryption logic 1404, storage logic 1406, second encryption logic 1408, replacing logic 1410, flowchart 400, flowchart 700, and/or flowchart 1200 may be implemented as computer program code (instructions) stored on a computer readable storage medium and configured to be executed in one or more processors. In another example, transmission control protocol (TCP) layer 210, selective-prioritization enabled PDCP layer 216, radio link control/medium access control (RLC/MAC) layer 222, physical layer 226, assignment logic 602, creation logic 604, low priority assignment logic 606, high priority assignment logic 608, encrypting and storage logic 1102, allocation determination logic 1104, packet determination logic 1106, encryption logic 1108, re-encrypting and storing queue logic 1402, first encryption logic 1404, storage logic 1406, second encryption logic 1408, replacing logic 1410, flowchart 400, flowchart 700, and/or flowchart 1200 may be implemented as hardware logic/electrical circuitry.

### IV. Example Computer Implementation

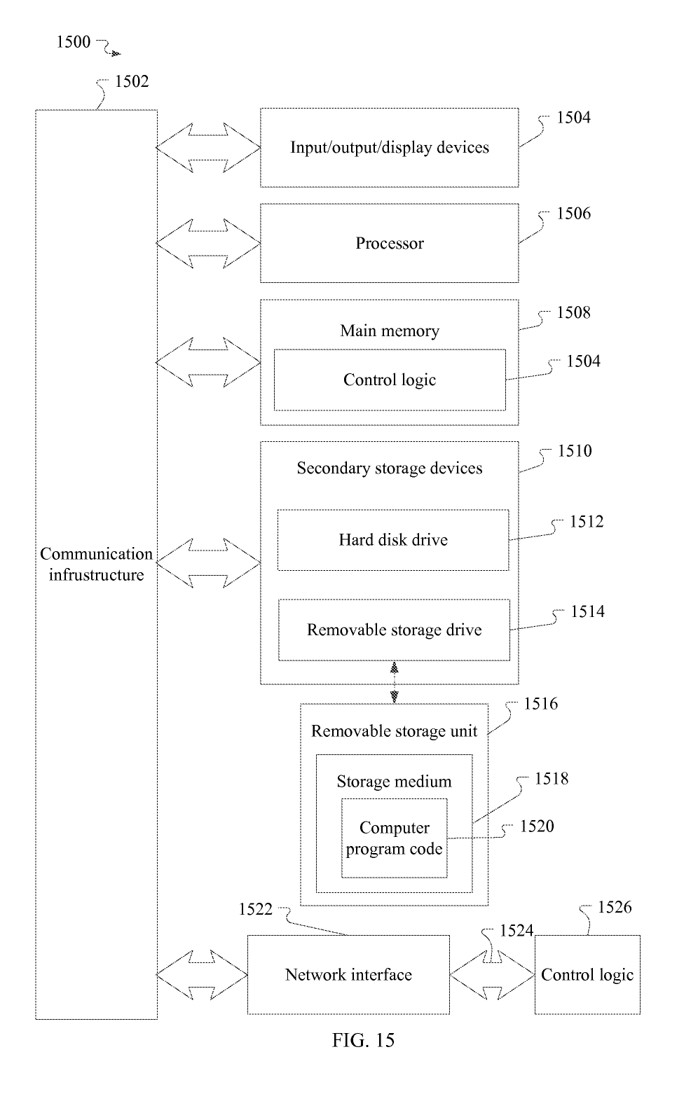

The embodiments described herein, including systems, methods/processes, and/or apparatuses, may be implemented using well known servers/computers, such as computer 1500 shown in FIG. 15. For example, elements of example communications system 100, including any of the user devices 102, 104, 106, base station 108, and server(s) 112 depicted in FIG. 1 and elements thereof, elements of example communications system 200, including the user device 202 and base station 236 depicted in FIG. 2 and elements thereof, each of the steps of flowchart 400 depicted in FIG. 4, each of the steps of flowchart 700 depicted in FIG. 7, and/or each of the steps of flowchart 1200 depicted in FIG. 12 can each be implemented using one or more computers 1500.

Computer 1500 can be any commercially available and well known computer capable of performing the functions described herein, such as computers available from International Business Machines, Apple, Sun, HP, Dell, Cray, etc. Computer 1500 may be any type of computer, including a desktop computer, a server, etc.

As shown in FIG. 15, computer 1500 includes one or more processors (e.g., central processing units (CPUs)), such as processor 1506. Processor 1506 may process and/or include transmission control protocol (TCP) layer 210, selective-prioritization enabled PDCP layer 216, radio link control/medium access control (RLC/MAC) layer 222, physical layer 226, assignment logic 602, creation logic 604, low priority assignment logic 606, high priority assignment logic 608, encrypting and storage logic 1102, allocation determination logic 1104, packet determination logic 1106, encryption logic 1108, re-encrypting and storing queue logic 1402, first encryption logic 1404, storage logic 1406, second encryption logic 1408, replacing logic 1410, flowchart 400, flowchart 700, and/or flowchart 1200; or any portion or combination thereof, for example, though the scope of the embodiments is not limited in this respect. Processor 1506 is connected to a communication infrastructure 1502, such as a communication bus. In some embodiments, processor 1506 can simultaneously operate multiple computing threads.

Computer 1500 also includes a primary or main memory 1508, such as a random access memory (RAM). Main memory has stored therein control logic 1504 (computer program code or instructions), and data.

Computer 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, computer 1500 may include an industry standard interface, such as a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer usable or readable storage medium 1518 having stored therein computer program code 1520 (control logic) and/or data. Removable storage unit 1516 represents a floppy disk, magnetic tape, compact disc (CD), digital versatile disc (DVD), Blue-ray disc, optical storage disk, memory stick, memory card, or any other computer data storage device. Removable storage drive 1514 reads from and/or writes to removable storage unit 1516 in a well-known manner.

Computer 1500 also includes input/output/display devices 1504, such as monitors, keyboards, pointing devices, microphones, motion capture devices, etc.

Computer 1500 further includes a communication or network interface 1522. Network interface 1522 enables computer 1500 to communicate with remote devices. For example, network interface 1522 allows computer 1500 to communicate over communication networks or mediums 1524 (representing a form of a computer usable or readable medium), such as local area networks (LANs), wide area networks (WANs), the Internet, etc. Network interface 1522 may interface with remote sites or networks via wired or wireless connections. Examples of network interface 1522 include but are not limited to a modem, a network interface card (e.g., an Ethernet card), a communication port, a Personal Computer Memory Card International Association (PCMCIA) card, a universal serial bus (USB) interface circuit/card, etc.

Control logic 1526 may be transmitted to and from computer 1500 via the communication medium 1524.

Any apparatus or manufacture comprising a computer usable or readable medium having control logic (computer program code or instructions) stored therein is referred to herein as a computer program product or program storage device. This includes, but is not limited to, computer 1500, main memory 1508, secondary storage devices 1510, and removable storage unit 1516. Such computer program products, having control logic stored therein that, when executed by one or more data processing devices, cause such data processing devices to operate as described herein, represent embodiments.

For example, each of transmission control protocol (TCP) layer 210, selective-prioritization enabled PDCP layer 216, radio link control/medium access control (RLC/MAC) layer 222, physical layer 226, assignment logic 602, creation logic 604, low priority assignment logic 606, high priority assignment logic 608, encrypting and storage logic 1102, allocation determination logic 1104, packet determination logic 1106, encryption logic 1108, re-encrypting and storing queue logic 1402, first encryption logic 1404, storage logic 1406, second encryption logic 1408, replacing logic 1410, flowchart 400, flowchart 700, and flowchart 1200 (including each step of flowcharts 400, 700, and 1200) can be implemented as control logic that may be stored on a computer usable storage medium or computer readable storage medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the present application. Thus, the breadth and scope of the present patent application should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, and computer readable medium is a machine or manufacture defined by 35 U.S.C. §101.

What is claimed is:

1. A method in a user device, comprising:
assigning one or more first sequence numbers from each of a plurality of subsets of sequence numbers to one or more data packets having a first priority, each subset further including one or more second sequence numbers; and
for each subset, not assigning the one or more second sequence numbers to a data packet having the first priority so that each subset includes one or more unassigned sequence numbers.

2. The method of claim 1, further comprising:
for at least one subset of the plurality of sequential subsets, subsequent to said assigning the one or more first sequence numbers, assigning at least one of the one or more second sequence numbers to at least one data packet having a second priority, the second priority being greater than the first priority.

3. The method of claim 2, wherein said assigning at least one of the one or more second sequence numbers to at least one data packet having a second priority comprises:
determining that a subset of second sequence numbers is locked for transmission from a user device to a base station;
wherein said assigning the at least one of the one or more second sequence numbers comprises:
assigning the at least one of the one or more second sequence numbers, which are not included in the subset of second sequence numbers, to the at least one data packet having the second priority in response to determining that the subset of second sequence numbers is locked.

4. The method of claim 2, wherein each subset includes a single first sequence number and a single second sequence number.

5. The method of claim 2, wherein each subset includes a single first sequence number and a plurality of second sequence numbers.

6. The method of claim 2, wherein for the at least one subset of the plurality of sequential subsets, assigning the at least one of the one or more second sequence numbers to the at least one data packet having the second priority comprises:
assigning the at least one of the one or more second sequence numbers to the at least one data packet having the second priority based on an uplink data rate with which the at least one data packet having the second priority is to be transmitted from a user device to a base station and a downlink data rate with which downlink data packets are transmitted from the base station to the user device.

7. The method of claim 1, wherein each subset includes the one or more first sequence numbers and a number of second sequence numbers, the number of second numbers based on a size of each of the one or more data packets that have the first priority in the subset.

8. The method of claim 1, further comprising:
selecting a number of second sequence numbers to be included in a subset based on a type of data packet having the first priority in the subset.

9. A method in a user device, comprising:
determining an estimated amount of data to provide in a single uplink allocation from the user device to a base station;
determining whether at least one data packet having a second priority that is greater than a first priority is available for encryption; and
encrypting a plurality of designated data packets to provide in the single uplink allocation for transmission to the base station, the plurality of designated data packets including one or more data packets having the first priority and no data packets having the second priority if no data packets having the second priority are available for encryption, the plurality of designated data packets including one or more data packets having the second priority and zero or more data packets having the first priority if at least one data packet having the second priority is available for encryption.

10. The method of claim 9, wherein determining the estimated amount of data comprises:
receiving a power indicator at the user device from the base station, the power indicator specifying the amount of power that the base station transmits to the user device; and
measuring, at the user device, the amount of power that the user device receives from the base station.

11. The method of claim 9, wherein determining the estimated amount of data further comprises:
calculating a plurality of user device transmit power values based on a plurality of respective data allocation sizes;
determining a minimum user device transmit power value of the plurality of user device transmit power values that provides a maximum data allocation size of the plurality of data allocation sizes that the base station can receive in a single uplink allocation; and
determining the estimated amount of data based on the maximum data allocation size.

12. The method of claim 11, wherein calculating a plurality of user device transmit power values based on a plurality of respective data allocation sizes comprises:
calculating the plurality of user device transmit power values based on the plurality of respective data allocation sizes while holding an error rate associated with transmission of the plurality of designated data packets from the user device to the base station constant.

13. The method of claim 9, wherein the estimated amount of data is an approximated maximum amount of data that the base station is capable of receiving from the user device in the single uplink allocation.

14. The method of claim 9, further comprising:
determining, during the uplink allocation, that at least one second data packet having the second priority is available for encryption; and
encrypting the at least one second data packet having the second priority in a next sequential uplink allocation.

15. The method of claim 9, wherein determining whether at least one data packet having the second priority is available for encryption comprises:
determining that at least one data packet having the second priority is available for encryption; and
wherein the at least one data packet includes one or more transmission control protocol acknowledgement (TCP ACK) packets.

16. The method of claim 9, wherein determining whether at least one data packet having the second priority is available for encryption comprises:
determining that a designated number of data packets having the second priority are available for encryption; and
wherein the plurality of designated data packets includes the designated number of data packets having the second priority.

17. The method of claim 9, wherein determining the estimated amount of data, determining whether at least one data packet having the second priority is available for encryption, and encrypting the plurality of designated data packets is performed in lieu of encrypting data packets having the first priority and data packets having the second priority in an order in which the data packets having the first priority and the data packets having the second priority are received, based on one or more types associated with the data packets having the first priority.

18. The method of claim 9, wherein determining the estimated amount of data, determining whether at least one data packet having the second priority is available for encryption, and encrypting the plurality of designated data packets is performed in lieu of encrypting data packets having the first priority and data packets having the second priority in an order in which the data packets having the first priority and the data packets having the second priority are received, based on at least one of an uplink data rate with which data packets are transmitted from the user device to the base station or a downlink data rate with which downlink data packets are transmitted from the base station to the user device.

19. The method of claim 9, wherein determining whether at least one data packet having the second priority is available for encryption comprises:
determining that a designated number of data packets having the second priority are available for encryption; and
wherein the plurality of designated data packets includes a specified number of data packets having the second priority, the specified number being less than the designated number.

20. A method comprising:
encrypting one or more first data packets having a first priority to generate one or more encrypted data packets, each of the one or more first data packets encrypted based on a corresponding sequence number of a plurality of sequential sequence numbers;
storing the one or more encrypted data packets in a queue for subsequent transmission;
receiving one or more second data packets having a second priority that is greater than the first priority before transmission of a subset of the one or more encrypted data;
encrypting at least one of the one or more second data packets based on a corresponding sequence number reassigned from a corresponding first data packet of the subset;
re-encrypting a subset of the first data packets corresponding to the subset of the one or more encrypted data packets to generate a plurality of updated encrypted data packets that includes the re-encrypted subset and the encrypted at least one of the one or more second data packets; and
replacing the subset of the one or more encrypted data packets with the plurality of updated encrypted data packets in the queue for subsequent transmission.
